(19) United States
(12) Patent Application Publication
(10) Pub. No.: US 2011/0018704 A1
(43) Pub. Date: Jan. 27, 2011

(54) System, Device and Method for Providing Power Line Communications

(76) Inventor: Zachary M. Burrows, Germantown, MD (US)

Correspondence Address: CAPITAL LEGAL GROUP, LLC, 1100 River Bay Road, Annapolis, MD, 21409, US

(21) Appl. No.: 12/508,897

(22) Filed: Jul. 24, 2009

(51) Int. Cl. G08B 1/08

(52) U.S. Cl. 340/538

(57) ABSTRACT

A system, method and device for providing a power line communication system via an ad hoc network protocol is provided. In one embodiment, the method includes transmitting and receiving Alive Notifications via a power line. Each Alive Notification may include data identifying an interface of the transmitting power line node and information identifying an interface of one or more other power line nodes from which the transmitting node has previously received an Alive Notification and reliability information all such nodes. The method may further include regularly transmitting and receiving topology information and routing information via the power line and updating topology and routing information in memory. The method may further include selecting a route to a network for transmission of data based on the routing information stored in memory, wherein the selected route includes the fewest hops and satisfies reliability requirements. The method may further include identifying a first power line node that comprises the first hop of the selected route and transmitting data to the first power line node.

### FIELD OF THE INVENTION

The present invention generally relates to data communications over a power distribution system and more particularly, to a system, method and device that employs an ad hoc protocol to establish communications over power lines.

### BACKGROUND OF THE INVENTION

Well-established power distribution systems exist throughout most of the United States, and other countries, which provide power to customers via power lines. With some modification, the infrastructure of the existing power distribution systems can be used to provide data communication in addition to power delivery, thereby forming a power line communication system (PLCS). In other words, existing power lines that already have been run to many homes and offices, can be used to carry data signals to and from the homes and offices. These data signals are communicated on and off the power lines at various points in the power line communication system, such as, for example, near homes, offices, Internet service providers, and the like.

While the concept may sound simple, there are many challenges to overcome in order to use power lines for data communication. Overhead power lines are not designed to provide high speed data communications and are very susceptible to interference. Additionally, federal regulations limit the amount of radiated energy of a power line communication system, which therefore limits the strength of the data signal that can be injected onto power lines (especially overhead power lines). Consequently, due to the attenuation of the power lines, communications signals typically will travel only a relatively short distance on power lines. In addition, the distance may vary from location to location.

Power distribution systems include numerous sections, which transmit power at different voltages. The transition from one section to another typically is accomplished with a transformer. The sections of the power distribution system that are connected to the customers premises typically are low voltage (LV) sections having a voltage between 100 volts (V) and 240V, depending on the system. The sections of the power distribution system that provide the power to the LV sections are referred to as the medium voltage (MV) sections. The voltage of the MV section is in the range of 1,000V to 100,000V. The transition from the MV section to the LV section of the power distribution system typically is accomplished with a distribution transformer, which converts the higher voltage of the MV section to the lower voltage of the LV section.

Power system transformers are one obstacle to using power distribution lines for data communication. Transformers act as a low-pass filter, passing the low frequency signals (e.g., the 50 or 60 Hz) and impeding the high frequency signals (e.g., frequencies typically used for data communication). As such, power line communication systems face the challenge of communicating the data signals around, or through, the distribution transformers. In addition, power lines are susceptible to ingress noise, which may vary from location to location.

As a result, layout and network planning of a power line communications system is often difficult due to the unpredictability of the power line communications channels. For example, some power line communication systems (PLCSs) utilize a transformer bypass device to communicate around the distribution transformer. In addition, some PLCSs use repeating to extend the range of communications over power lines. However, placement and configuration of such devices (e.g., identifying gateways, repeaters, etc.) is very difficult prior to installation and, further, often may need to be re-configured. Thus, there is a need for a power line communications system that can dynamically configure and re-configure itself. These and other advantages may be provided by various embodiments of the present invention.

### SUMMARY OF THE INVENTION

The present invention provides a system, method and device for providing a power line communication system via an ad hoc network protocol. In one embodiment, the method includes transmitting and receiving Alive Notifications via a power line. Each Alive Notification may include data identifying an interface of the transmitting power line node and information identifying an interface of one or more other power line nodes from which the transmitting node has previously received an Alive Notification and reliability information all such nodes. The method may further include regularly transmitting and receiving topology information and routing information via the power line and updating topology and routing information in memory. The method may further include selecting a route to a network for transmission of data based on the routing information stored in memory, wherein the selected route includes the fewest hops and satisfies reliability requirements. The method may further include identifying a first power line node that comprises the first hop of the selected route and transmitting data to the first power line node.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a diagram of an exemplary power distribution system with which the present invention may be employed;

FIG. 2 is a diagram of a portion of an example power line communications system, with may be used to implement the present invention;

FIG. 3 is a schematic representation of a portion of an exemplary power distribution system;

FIG. 4 is a block diagram of a bypass device, in accordance with an example embodiment of the present invention;

FIG. 5 is a block diagram of a bypass device, in accordance with an example embodiment of the present invention;

FIG. 6a is a flow chart of a node discovery and reliability method, in accordance with an example embodiment of the present invention;

FIG. 6b is a flow chart of a topology exchange method, in accordance with an example embodiment of the present invention;

FIG. 7 is a flow chart of a routing information exchange method, in accordance with an example embodiment of the present invention;

FIG. 8 is a flow chart of a routing path selection method, in accordance with an example embodiment of the present invention; and

FIG. 9 is a timeline of a portion of the communications for determining and using a routing path for transmitting data, in accordance with an example embodiment of the present invention.

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, operating systems, development interfaces, and hardware are omitted so as not to obscure the description of the present invention.

### System Architecture and General Design Concepts

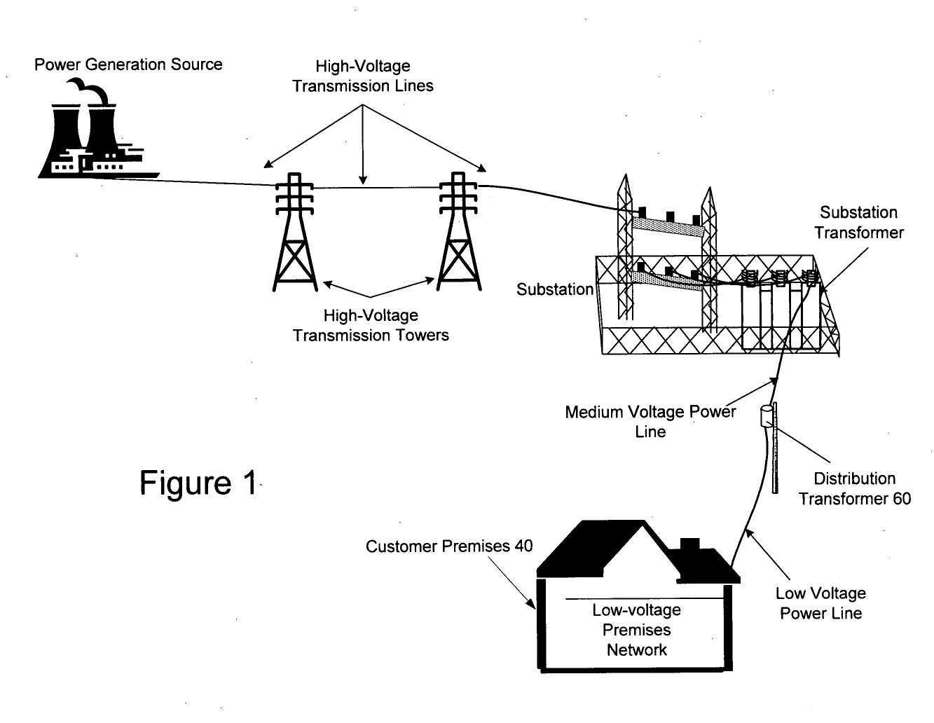

As shown in FIG. 1, power distribution systems typically include components for power generation, power transmission, and power delivery. A transmission substation typically is used to increase the voltage from the power generation source to high voltage (HV) levels for long distance transmission on HV transmission lines to a substation. Typical voltages found on HV transmission lines range from 69 kilovolts (kV) to in excess of 800 kV.

In addition to HV transmission lines, power distribution systems include MV power lines and LV power lines. As discussed, MV typically ranges from about 1000 V to about 100 kV and LV typically ranges from about 100 V to about 240 V. Transformers are used to convert between the respective voltage portions, e.g., between the HV section and the MV section and between the MV section and the LV section. Transformers have a primary side for connection to a first voltage (e.g., the MV section) and a secondary side for outputting another (usually lower) voltage (e.g., the LV section). Such transformers are often referred to as distribution transformers or a step down transformers, because they “step down” the voltage to some lower voltage. Transformers, therefore, provide voltage conversion for the power distribution system. Thus, power is carried from substation transformer to a distribution transformer over one or more MV power lines. Power is carried from the distribution transformer to the customer premises via one or more LV power lines.

In addition, a distribution transformer may function to distribute one, two, three, or more phase voltages to the customer premises, depending upon the demands of the user. In the United States, for example, these local distribution transformers typically feed anywhere from one to ten homes, depending upon the concentration of the customer premises in a particular area. Distribution transformers may be pole-top transformers located on a utility pole, pad-mounted transformers located on the ground, or transformers located under ground level.

The communication device of the present invention may form part of a PLCS to communicate signals to and from communication devices at the customer premises through the LV power line. In addition, the communications device of the present invention may facilitate the communication of data signals along the MV power line with 1) other power line communication devices such as bypass devices; 2) one or more backhaul points; 3) one or more power line servers; and/or 4) devices on a network such as the Internet.

### Power Line Communication System

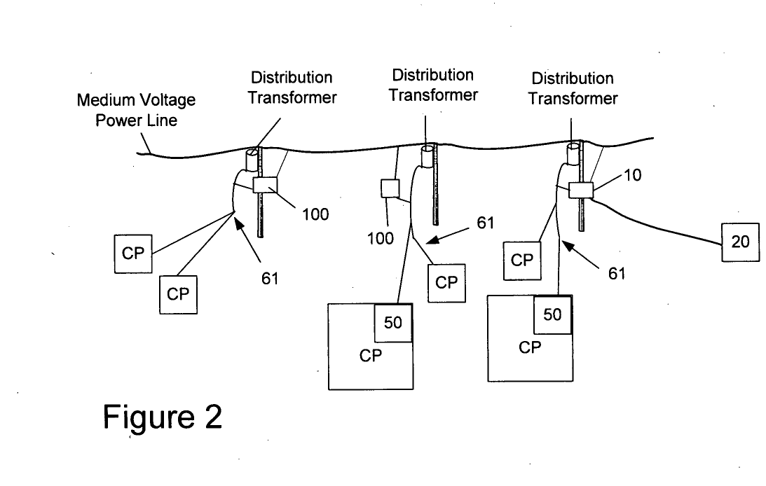

One example of a portion of such a PLCS is shown in FIG. 2 and includes one or more bypass devices 100, which may be formed by an embodiment of the present invention. In this example, the present invention may be implemented in a bypass device (BD) 100, which communicates data signals around the distribution transformer that would otherwise filter such data signals, preventing them from passing through the transformer or significantly degrading them. Thus, the BD 100 is the gateway between the LV power line subnet 61 (i.e., the devices that are communicatively coupled to the LV power lines) and the MV power line and communicates signals to and from user devices (and utility meters) at the customer premises (CP) via the low voltage subnet 61.

In this embodiment, the BD 100 provides communication services for the user (and meters), which may include security management, routing of Internet Protocol (IP) packets, filtering data, access control, service level monitoring, signal processing and modulation/demodulation of signals transmitted over the power lines.

This example portion of a PLCS also includes a backhaul point 10, which may also implement the present invention. The backhaul point 10 is an interface and gateway between a portion of a PLCS (e.g., an MV run) and a traditional non-power line telecommunications network such as fiber, coaxial cable, or wireless. One or more backhaul points (BP) 10 are communicatively coupled to an aggregation point (AP) 20 that in many embodiments may be at (e.g., co-located with), or connected to, a point of presence (POP) to the Internet. The BP 10 may be connected to the AP 20 using any available mechanism, including fiber optic conductors, T-carrier, Synchronous Optical Network (SONET), or wireless techniques well known to those skilled in the art. Thus, the BP 10 may include a transceiver suited for communicating through the communication medium.

The AP 20 may include a conventional Internet Protocol (IP) data packet router and may be directly connected to an Internet backbone thereby providing access to the Internet. Alternatively, the AP 20 may be connected to a core router (not shown), which provides access to the Internet, or other communication network. Depending on the configuration of the PLCS, a plurality of APs 20 may be connected to a single core router which provides Internet access. The core router (or AP 20 as the case may be) may route voice traffic to and from a voice service provider and route Internet traffic to and from an Internet service provider and/or video provider. The routing of packets to the appropriate provider may be determined by any suitable means such as by including information in the data packets to determine whether a packet is voice. If the packet is voice, the packet may be routed to the voice service provider and, if not, the packet may be routed to the Internet service provider. Similarly, the packet may include information (which may be a portion of the address) to determine whether a packet is Internet data. If the packet is Internet data, the packet may be routed to the Internet service provider and, if not, the packet may be routed to the voice service provider. Additionally, if the packet includes voice, video or other time sensitive data, it may be accorded a higher priority to thereby reduce the latency thereof.

In some PLCS embodiments, there may a distribution point (not shown) between the BP 10 and the AP 20. The distribution point, which includes a router, may be coupled to a plurality of BPs 10 and provides routing functions between its BPs 10 and its AP 20. In one example embodiment, a plurality of BPs 10 are connected to each distribution point and each distribution point (of which there are a plurality) is coupled to the AP 20, which provides access to the Internet.

The PLCS also may include a power line server (PLS) that is a computer system with memory for storing a database of information about the PLCS and includes a network element manager (NEM) that monitors and controls the PLCS. The PLS allows network operations personnel to provision users and network equipment, manage customer data, and monitor system status, performance and usage. The PLS may reside at a remote network operations center (NOC), and/or at a PLCS Point of Presence (POP), to oversee a group of communication devices via the Internet. The PLS may provide an Internet identity to the network devices by assigning the devices (e.g., user devices, BDs 100, (e.g., the LV modems and MV modems of BDs), BPs 10, and AP 20) IP addresses and storing the IP addresses and other device identifying information (e.g., the device's location, address, serial number, etc.) in its memory. In addition, the PLS may approve or deny user devices authorization requests, command status reports, statistics and measurements from the BDs, and BPs, and provide application software upgrades to the communication devices (e.g., BDs, BPs, and other devices). The PLS, by collecting electric power distribution information and interfacing with utilities' back-end computer systems may provide enhanced power distribution services such as automated meter reading, outage detection, restoration detection, load balancing, distribution automation, Volt/Volt-Amp Reactance (Volt/VAR) management, and other similar functions. The PLS also may be connected to one or more APs and/or core routers directly or through the Internet and therefore can communicate with any of the BDs, user devices, and BPs through the respective AP and/or core router.

The PLCS may further include indoor low voltage repeaters and outdoor low voltage repeaters. Indoor low voltage repeaters may be plugged into a wall socket inside the customer premises. Outdoor low voltage repeaters may be coupled to the external low voltage power line conductors extending from the transformer and therefore, be located between the customer premises and the BD 100. Both the indoor low voltage repeaters and outdoor low voltage repeaters repeat data on the low voltage power line to extend the communication range of the BD 100 and power line modem.

At the user end of the PLCS of this example system, data flow originates from a user device, which provides the data to a power line modem (PLM) 50.

Various electrical circuits within the customer's premises distribute LV power and data signals within the customer premises. The customer draws power on demand by plugging a device into a power outlet. In a similar manner, the customer may plug a PLM 50 into a power outlet to digitally connect user devices to communicate data signals carried by the LV wiring. The PLM 50 thus serves as an interface for user devices to access the PLCS. The PLM 50 can have a variety of interfaces for customer data appliances. For example, a PLM 50 can include a RJ-11 Plain Old Telephone Service (POTS) connector, an RS-232 connector, a USB connector, a Ethernet 10 Base-T connector, RJ-45 connector, and the like. In this manner, a customer can connect a variety of user devices to the PLCS. Further, multiple PLMs can be plugged into power outlets throughout the customer premises, with each PLM 50 communicating over the same wiring internal of the customer premises to the BD 100.

The user device connected to the PLM 50 may be any device capable of supplying data for transmission (or for receiving such data) including, but not limited to a computer, a telephone, a telephone answering machine, a fax, a digital cable box (e.g., for processing digital audio and video, which may then be supplied to a conventional television and for transmitting requests for video programming), a video game, a stereo, a videophone, a television (which may be a digital television), a video recording device (which may be a digital video recorder), a home network device, a utility meter, or other device. The PLM 50 transmits the data received from the user device through the LV power lines to a BD 100 and provides data received from the LV power line to the user device. The PLM 50 may also be integrated with the user device, which may be a computer. In addition, the functions of the PLM may be integrated into a smart utility meter such as a gas meter, electric meter, water meter, or other utility meter to thereby provide automated meter reading (AMR).

The BD 100 typically transmits the data to (and receives the data from) the backhaul point 10, which, in turn, transmits the data to (and receives the data from) the AP 20. The AP 20 then transmits the data to (and receives the data from) the appropriate destination (perhaps via a core router), which may be a network destination (such as an Internet address) in which case the packets are transmitted to, and pass through, numerous routers (herein routers are meant to include both network routers and switches) in order to arrive at the desired destination.

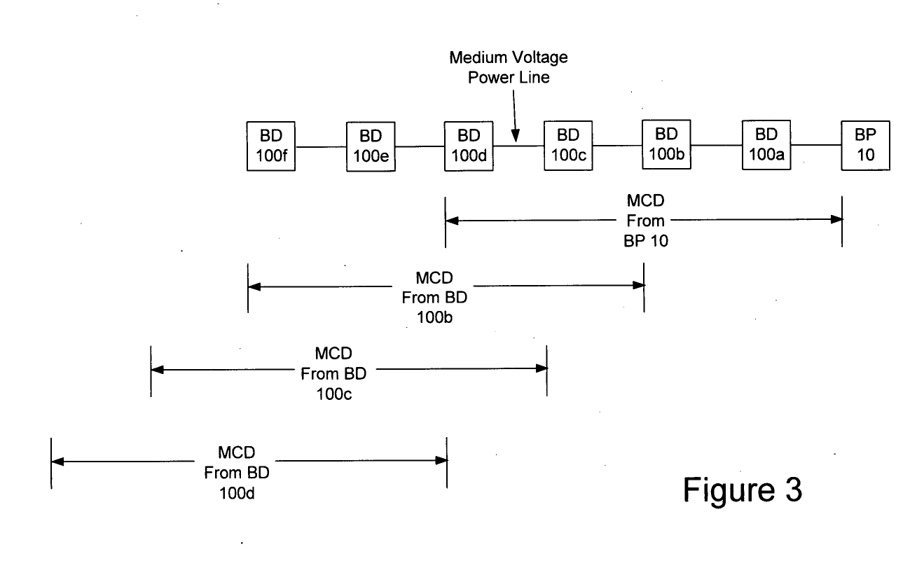

FIG. 3 provides a schematic representation of a segment of the medium voltage power line of an example portion of a PLCS. As shown, this example includes one BP 10 and six BDs 100a-f. While not shown in FIG. 3, the BP 10 may be communicatively coupled to another set of bypass devices (e.g., on the other side of the BP 10). In addition, the BDs 100a-f may or may not be on the same power line conductor as the BP 10 (because the data signals may cross couple between MV conductors through air). Communications in this example are point-to-multipoint in that the BP 10 transmits communications signals on the MV power line, which may be received by all of the BDs 100. The communications may include addressed data packets (e.g., internet protocol (IP) data packets). Consequently, while all of the BDs 100 may receive the data packets, only the BD 100 having an address corresponding to the address in the packet processes the packet. Typically, the other BDs 100 will ignore packets not containing their address information. In this example, transmissions from the BDs 100 will include address information of the BP 10, which typically will receive and process the transmissions. While the BDs 100 may receive the transmissions from the other BDs 100, normally they will ignore those transmissions because the packets will not have the address information of the receiving BD 100 (but instead have the address of the BP 10).

Referring to FIG. 3, if the BP 10 and a BD 100 are too far apart (along the MV power line), noise and attenuation over the power line(s) of the communications signals may prevent reliable communications between the two devices. Thus, the PLCS may have a maximum communications distance (MCD) (along the MV power line) over which a BP 10 and a BD 100 may communicate reliably. In addition, this distance may vary from location to location (e.g., from street to street) and over time, which makes planning the PLCS network difficult. If, after installation, a communication link between a BD 100 and its BP 10 is unreliable, one option is to install a second BP 10 closer to the BD 100 to service the BD 100. However, installation of BPs can be costly due to costs of installation time, equipment, and the necessity of providing a backhaul link, which may require installing a fiber optic cable or wireless backhaul link.

In addition to the above, due to noise and other factors the communications link between a BD 100 and its BP 10 may be reliable at times and unreliable at other times and/or may become unreliable sometime after installation of the network. Again, one solution is to install a new BP 10 closer to the BD 100 for communications, to service the BD 100. However, as discussed above, this solution is costly. Another solution to the problem is to install a dedicated repeater between the BP 10 and the BD 100. However, typically this requires sending personnel to perform the installation of the repeater (i.e., a truck roll), which can be costly and can take days or weeks to complete during which time the subscriber of the PLCS service may be without reliable service or without any service.

The present invention may reduce the need to install additional BPs, backhaul links, and dedicated repeater devices by extending the reach of existing BPs beyond the MCD through the use of existing network elements.

As an example, the MCD of BP 10 in FIG. 3 is such that it can communicate with BDs 100a-d, but can not directly reliably communicate with BD 100e or BD 100f. The MCDs of BDs 100b-d are similarly shown. However, BDs 100b-d are located such that any of BDs 100b-d can directly reliably communicate with BP 10 and both BDs 100e and BD 100f. The present invention allows any of the BDs 100 to repeat data for any other BD or the BP on an ad hoc basis. More specifically, by cooperating and exchanging information with each other, each BD may dynamically determine the “best” path for communicating data to any destination without the need to send personnel (or equipment) to the site or to receive commands from a remote computer system.

This example embodiment of the present invention comprises a bypass device that operates as a network element that can repeat (receive and re-transmit data) communications. The repeating functionality of the device allows the MCD or communications range of a BP 10 to be expanded such that communications devices (e.g., BDs 100) with unsatisfactory connectivity (e.g., due to noise or attenuation of signals) can be improved by repeating to make their connections satisfactory. In addition, the repeating functionality typically will extend the ‘reach’ of the BP 10 to include communications devices at distances that normally could not be reached by direct transmission between the device and the BP 10. Because the repeating functionality of a BD 100 reduces the number of BPs 10 needed to be deployed to cover the geographical area of a PLCS, it also reduces the amount of backhaul media (e.g., fiber optic cable or wireless links) that needs to be deployed, thereby providing a significant economic improvement to the PLCS.

In addition, the present invention allows for self-configuration of the network so that each BD generates its own routing table and identifies its own gateway(s) for transmitting data.

In this embodiment, a single device may repeat communications for other devices coupled to the MV power line and also provide communications to one or more user devices/meters (such as those connected to the LV subnet or that are linked to the device via a wireless link).

In this embodiment, a BD 100 may receive downstream packets addressed to it from a BP 10 or another BD 100 and may retransmit them on the MV power line for reception by another BD 100. Likewise, the BD 100 may receive packets addressed to it that are transmitted from one or more BDs 100 and retransmit those packets on the MV power line for reception by the BP 10. Thus, the repeater functionality of the BD 100 may extend the communications reach in such a way as to allow devices coupled to the MV power line that cannot communicate with BP 10, to be able to communicate with that BP and operate as a child device of that BP 10.

The embodiment described below includes a BD 100 that operates as BD 100 for bypassing a pole-mounted transformer. The present invention may be equally applicable for use in bypassing other types of transformers (such as pad mount or underground). The BD 100 may provide a path for data to bypass the transformer by being coupled to the same MV power line conductor to which the transformer is coupled or to a different MV power line conductor and, in either instance, may be coupled to the same LV power lines to which the bypassed transformer is coupled. In addition, the BDs 100 may or may not be physically coupled to the same power line conductor to which the BP 10 is physically connected. For example, in overhead PLCSs, high frequency data signals may cross-couple between the power line conductors.

Hardware

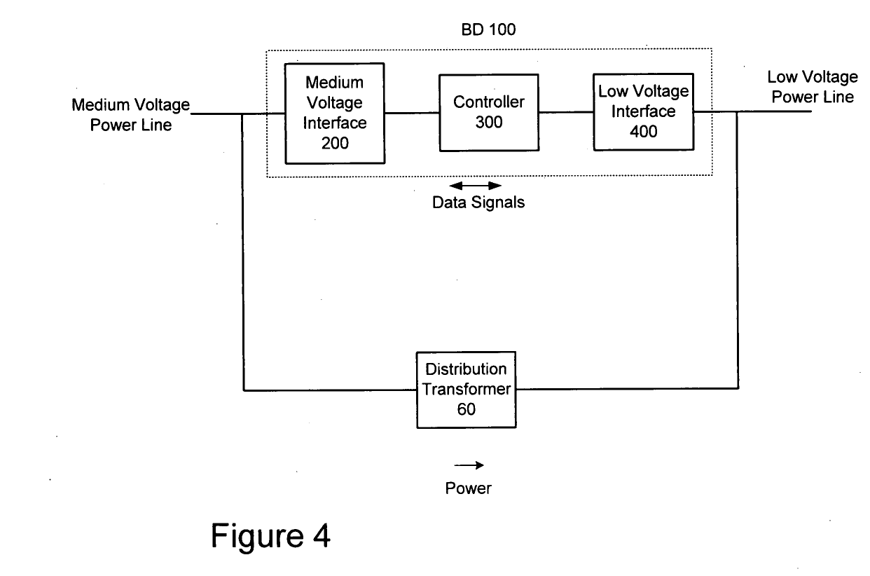

The BD 100 described herein, which is an example implementation of an example embodiment of the present invention, provides bidirectional communications and includes the functional block diagrams shown in FIG. 4. In particular, this embodiment of the BD 100 includes a MV power line interface (MVI) 200, a controller 300, and a LV power line interface (LVI) 400. Both the MVI and LVI may include an adaptive and/or dynamic transmitter to transmit signals at various power levels as determined by the controller 300, which may change the output power in response to a command from the PLS or automatically due to changes in line impedance. The BD 100 is controlled by a programmable processor and associated peripheral circuitry, which form part of the controller 300. The controller 300 includes memory that stores, among other things, routing information and program code, which controls the operation of the processor.

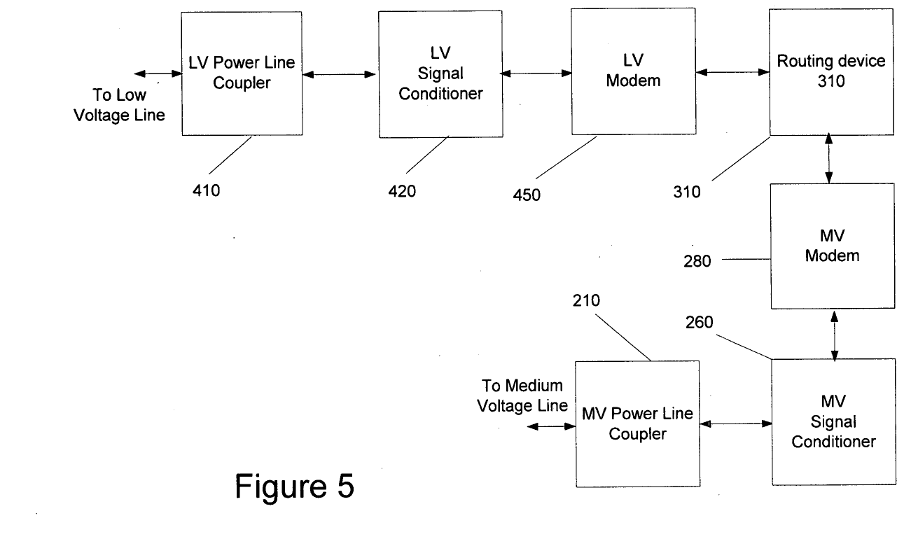

Referring to FIG. 5, the LVI 400 may include a LV power line coupler 410, a LV signal conditioner 420, and a LV modem 450. The routing device 310 may form part of the controller 300 and performs routing functions. Routing device 310 may perform routing functions using layer 3 data (e.g., IP addresses), layer 2 data (e.g., MAC addresses), or a combination of layer 2 and layer 3 data (e.g., a combination of MAC and IP addresses) and therefore act as a router, bridge or switch. The MVI 200 may include a MV modem 280, a MV signal conditioner 260, and a power line coupler 210. In addition to routing, the controller 300 may perform other functions including controlling the operation of the LVI 400 and MVI 200 functional components and responding to PLS commands and requests. A more complete description of the hardware, firmware, of the BD 100 and its functionality is described below. In addition, in this embodiment the controller 300 implements the processes of the ad hoc protocol as described below.

This embodiment of the BD 100 provides bidirectional communications around the distribution transformer to thereby provide a first communications path from the LV power line to the MV power line and a second path from the MV power line to the LV power line. Thus, BD 100 can receive and transmit data to one or more user devices at or in one or more customer premises via the LVI 400, which may be connected to a plurality customer premises via a plurality of LV power lines. In addition, the BD 100 may receive and transmit data to other network elements, such as one or more BPs 10 and other BDs 100, via the MVI 300.

Ad hoc Protocol for Determining Data Routing

Each BD 100 may transmit and receive data from one or more customer premises (CP) via an LV subnet 61 (see FIG. 2). Such data, for example, may originate from, or be sent to, an outside network, such as the internet. In some instances such data (such as data received via the Internet) may be sent to another LV subnet 61. The path that the data takes is referred to herein as a routing path. Various routing paths may be available for each BD 100 (or BP) for transmitting data to a given network. For communications with an external network, any given routing path includes at least a BP 10 (and, possibly, one or more other intermediate BDs 100) as well as an aggregation point 20, and ultimately to a POP for the outside network. In other systems, the routing path may include different devices. For communications with any remote user device or utility meter (i.e., a user device or meter connected to an LV subnet 61 other than the LV subnet to which the BD 100 (or BP) is electrically connected), the routing path includes at least the BD 100 serving the other LV subnet 61 and, possibly, one or more other intermediate BDs 100. The present invention may be implemented to determine a routing path in accordance with various design constraints. In this example embodiment, each network element (e.g., BD 100 and BP 10) of the system is designed to select a routing path first having the shortest number of hops to a given destination network. Where multiple routing paths have the same number of hops available, the path with the highest reliability of communications is used. In other embodiments, the system may instead be designed according to the present invention to select the routing path with the highest reliability. The determination of a routing path results in a selection of the next hop (i.e., the device to which the data packet will be transmitted). While each BD 100 may determine a routing path, in actuality it is really only determining the next hop (i.e., the device to which the BD will transmit the data) because the receiving device may also perform the same process of determining the “best” routing path and selection of the next (subsequent) hop.

According to an example embodiment of the present invention, each power line network element (e.g., BD 100, BP 10) may determine a routing path for transmitting data to a network by identifying the routing path having the fewest number of hops given pre-defined constraints (e.g., reliability no less than X). In effect, the fewest number of hops meeting satisfactory reliability criteria may be selected. Further, such assessment of reliability and fewest hops may be updated regularly. Rather than have each network element define its path in isolation, however, a plurality of network elements collectively provide each other with data allowing each given network element to more effectively determine various routing paths.

Several processes may be implemented to select and update a given network element's routing path. In an example embodiment of the present invention, a method for discovering other network elements is implemented. In addition a method of exchanging topology information, routing information and selecting a specific routing path to thereby select the next hop is implemented. Each of these methods may include various processes performed periodically or aperiodically at the same or at different intervals. The method of discovering other network elements is useful for determining the reliability for communicating with each of the discovered network elements and generating routing information. The method of exchanging topology information facilitates creating of a routing table. The method of exchanging routing information is useful for generating new routing information. For example, cost metrics and communication node availability information may be exchanged to allow network elements to better determine a routing path. In this example, the method of selecting the routing path may identify a routing path with the fewest hops and, if multiple paths exist with the same number of hops, the method assesses the reliability of such paths to select the routing path with the highest overall reliability. Such routing path may remain in effect until replaced by a different path during a successive execution of the routing path selecting method.

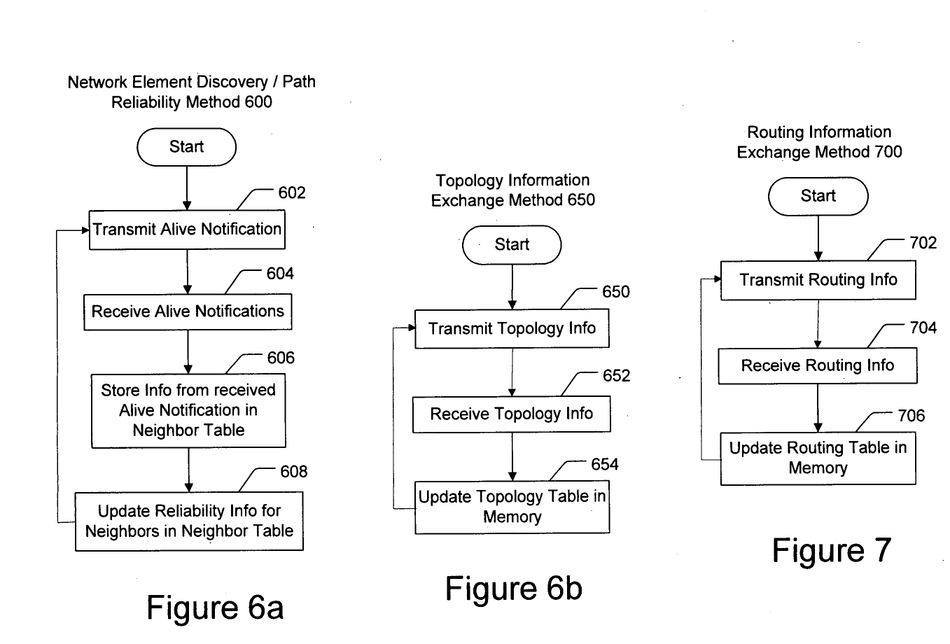

FIG. 6a illustrates processes involved in a method 600 of discovering communication nodes and determining path reliability, according to an example embodiment of the present invention. The method 600 serves to identify network element neighbors and establish neighbor relationships (i.e., to identify the network elements within communication range) between network elements. It may be executed by each BD 100, BP 10 and/or other power line network element and would typically be executed by all the network elements of the network. At step 602, the network element broadcasts or otherwise transmits an Alive Notification to other network elements via the MV power line. The Alive Notification may be transmitted on a recurring basis without regard for the status of any neighboring network element. In one example embodiment, messages and protocol of the Optimized Link State Routing Protocol (OLSR) may be employed to implement the present invention. OLSR is a proactive link state routing protocol which uses Hello and Topology Control (TC) messages to discover and then disseminate link state information throughout the network. Individual network elements may use this topology information to compute next hop destinations for all nodes in the network using shortest hop forwarding paths. In such an embodiment, the Hello message of the OLSR may serve as an Alive Notification.

In addition, Alive Notifications may be used to determine Multi-Point Relays (MPRs) for a network element. A Multi-Point Relay is a network element that is used to forward broadcast control messages (e.g., Topology Control Messages) between network elements that cannot directly communicate with each other. An MPR forwards broadcast control messages to network elements that are two hops away from the transmitting network element (i.e., have one intermediate hop between them which acts as the MPR). MPR selection is done on a per network element basis and each network element may use different network elements for its MPRs. MPRs are selected from a network element's one hop (directly seen) network element neighbors. MPRs are also used to constrain broadcast retransmissions.

In an example embodiment, the Alive Notification includes data identifying an interface of the transmitting network element (e.g., an address associated with the device or of the MV interface of the device) and may include data identifying all other network elements from which the transmitting network element has received an Alive Notification (data from a neighbor table described below). The Alive Notification also may include reliability information for the other network elements from which the transmitting network element has received an Alive Notification. At power up a first Alive Notification is transmitted by the network element and there may not be any data available about other network elements included in the Alive Notification. As the method 600 is repeated by the various network elements, a transmitting network element may have received Alive Notifications from other network elements and would compile or otherwise generate reliability information for those other network elements. In some embodiments the Alive Notification may be encrypted to ensure restricted access. Accordingly, the purpose of an Alive Notification is to announce a power line network element's presence on the power line and to establish neighbor relationships.

All of the network elements may also listen for and receive Alive Notifications. At step 604, the network element implementing process 600 receives an Alive Notification from another network element. While step 604 is illustrated as a separate and single process in FIG. 6a, each of the network elements may typically continuously listen for Alive Notifications and may receive multiple Alive Notifications each cycle.

Each network element may store and maintain a neighbor table in memory. At step 606, the given network element receiving an Alive Notification may process data from the received Alive Notification and store the data of the Alive Notification in the neighbor table. As indicated above, the received Alive Notification may include information identifying (1) the interface of the transmitting network element, (2) the interfaces of the network elements from which the transmitting network element has received Alive Notifications, and (3) reliability information concerning all such transmitting network elements. In this example, the identifying information of an interface (the interface with which the receiving network element communicates) of the transmitting network element may comprise a MAC address (or, alternately an IP address) associated with the medium voltage modem of the network elements. When subsequently transmitting an Alive Notification, the network element may include all or a portion of the information in its neighbor table in its Alive Notification. As an example, after receiving an Alive Notification from five different network elements at a first network element, the first network element would have stored information identifying the MV interfaces (e.g., MAC addresses) of the five network elements, information identifying all of the MV interfaces of the network elements from which each of the five network elements have received an Alive Notification, and reliability information that relates to the communications between first network element and the five network elements, and reliability information that relates to the communications between five network elements and each network element from which they received an Alive Notification. All such information, in this example, is stored in neighbor table of the first network element.

As discussed, a received Alive Notification may be used to determine neighbor availability and reliability. Failure to timely receive an Alive Notification from a network element may adversely impact reliability for communicating with such network element. At step 608, the network element updates the reliability information in its neighbor table. Updating of reliability information for the given network element's various neighboring network elements may be executed at various times but would typically occur upon receipt of a new Alive Notification and/or at the end of a time period or cycle (e.g., during which an expected Alive Notification is not received).

As previously discussed, the process of transmitting an Alive Notification may be performed regularly. The specific time interval or cycle may be fixed or variable at some predetermined, selected or derived time interval. Consider an example, where the time interval is five minutes. The starting time for an interval may differ for differing network elements. However for this example, the given network element may expect to hear from all of its neighbors once every five minutes. If an Alive Notification is not received from a neighbor within its five minute window, the network element expecting the Alive Notification will update its neighbor table by reducing the reliability indicator associated with that neighbor (i.e., the neighbor from which it did not receive a timely Alive Notification). After another five minutes, if an Alive Notification still has not been received from that same neighbor, the reliability indicator of that neighbor in the neighbor table may be further reduced. If a given network element does not hear from a neighbor for another predetermined time period (e.g., thirty minutes) the information attributable to that network element (its identity, the network elements from which it has received Alive Notifications and reliability information) may be deleted from the neighbor table. Accordingly, the option of specifying a routing path including such neighbor network element is removed when an Alive Notification is not received within some predetermined time period. This allows for a self-healing of a network in that, should a particular network element fail, the other network elements become aware of its failure (by not receiving Alive Notifications) and will use other routing paths accordingly.

In some embodiments, removed information also may encompass other data, such as data that was previously received from the neighbor's Alive Notification, (e.g., data from neighbor's neighbor table). Accordingly, loss of Alive Notifications adversely impacts routing path costs and neighbor availability determinations. Following any update of a network element's neighbor table, the subsequent Alive Notification broadcast by that network element will reflect the newly updated reliability data. Accordingly, as Alive Notifications are received (and not received) from respective network elements, neighbor table reliability information is updated with regard to neighboring network elements. In summary, in addition to storing data based on received Alive Notifications at step 606, the failure to timely receive an Alive Notification may cause the neighbor table to be updated at step 608 by removing (or modifying reliability) data associated with a network element from which an Alive Alert had been previously received.

In addition, in other embodiments the channel may be assessed such as by determining a bit error rate of data communicated between network elements to determine reliability over a link. In addition, the physical layer may be assessed to determine the reliability of a channel in some embodiments. For example, the signal to noise ratio of received data signals may be determined by the receiving network element to provide reliability information, which is stored in memory.

Referring to FIG. 6b, each of the network elements may transmit and receive topology information, which includes identifying information of each network element (e.g., an IP address associated with the transmitting device) and may include path costs to one or more (or all) network elements. Once neighbor relationships (Alive Notifications exchanges) are established, topology information may be exchanged between all network elements within the network via TC (Topology Control) messages. TC messages are transmitted (broadcast) out the MV interface over the MV power line to other network elements at 650. TC messages may utilize MPRs for message distribution to network elements that are not a first hop to the transmitting network element. The MPR will forward the received messages between network elements that cannot directly communicate with each other. TC messages may be broadcast periodically such as every ten minutes (i.e., less often than the Alive Notifications). Each network element includes in the TC message it sends, information of all of its interfaces that are communicating on that network via the protocol, which may be, for example, the LV interface and the MV interface. Each network element receives topology information at 652. As with Alive Notifications, topology information may be transmitted once per a given cycle. However, each network element may continuously listen for TC messages and may receive multiple TC messages per TC cycle. In addition, each network element stores and maintains a full topology table of the entire network based on the TC messages it receives. Thus, at 654 a topology table in memory is updated in accordance with information received. Once topology information is exchanged, topology maps may be generated.

Network elements within the network in some embodiments need to calculate path costs between neighbors in order to establish the most effective communication paths available. The failure to receive Alive Notification messages (neighbor availability) impacts Link Quality (LQ). LQ is simply the probability that Alive Notification messages are exchanged properly. For example, 30% loss of Alive Notification messages equals an LQ of 70% availability or reliability (or 0.70). Because communication paths are bidirectional, each direction of a communication link may have different LQ values. Consequently, round trip communication link LQ assessments are performed. A round trip LQ assessment is know as an NLQ (Neighbor Link Quality) and may be computed as the multiplication of each leg's LQ values. The NLQ value is the probability of the two communication links. For example, where LQ_{Node1-to-Node2}=0.7 and LQ_{Node2-to-Node1}=0.6, then NLQ=(0.7)(0.6)=0.42 or 42% availability. The LQ and NLQ values are combined to create the ETX (Expected Transmission Count) value, which in this embodiment, may be used as the path costs. Generally, the higher the ETX, the higher the path cost and an ideal ETX value is 1. ETX may be calculated as follows:

$$E T X = ( \frac{1}{( N L Q ) ( L Q )} )$$

An example ETX is as follows where LQ_{Node1-to-Node2}=0.7 and NLQ=0.42

$$E T X = 3.401 = ( \frac{1}{( 0.42 ) ( 0.7 )} )$$

Other methods of computing or estimating path costs may also be used.

FIG. 7 illustrates a method of exchanging routing path information 700 to be executed by each network element, according to an example embodiment of the present invention. Once initial neighbor relationships are established at startup and topology information has been exchanged, routing information may be exchanged concomitantly with the updating of the neighbor relations. Various methods may be implemented, such as unicasting and broadcasting methods. In a specific embodiment, routing information is exchanged between neighbors via a combination of unicast and broadcast information exchanges. While not shown in the figure (to avoid confusion), each network element may generate an initial routing table based on the neighbor table and topology table and store the initial routing table in memory.

In an example embodiment, each network element may maintain a full routing table for an entire network (e.g., a power line communication system (PLCS) network) or some portion thereof (e.g., a PLCS sub-network; a set of LV subnets 61; all neighbors within ‘n’ hops). Further, each network element may generate its own routing information based on the routing information received from other network elements. A network element may update its full routing table and transmit the routing table during a routing exchange process. In one example, to maintain a full routing table each network element may periodically transmit a host and network association (HNA) message to one or more other network elements (i.e., transmitted via the MV interface over the power line). Accordingly, at step 702 a given network element may transmit routing information to one or more network elements identified in its neighbor table (e.g., all of the network elements from which it has received an Alive Notification). The HNA message may include routing information that identifies the transmitting network element and all the networks (e.g., the LV subnets 61 and other networks) with which the transmitting network element the can communicate (directly or indirectly via one or more hops), including its own LV subnet 61.

In addition, other network elements (e.g., one on each side of the transmitting network element along the MV power line) may act as a MPR and re-transmit the HNA message to more distant network elements. In this embodiment, the routing information is broadcast at the same interval as the TC messages, although in other embodiments the interval for each may be different. In some embodiments, HNA messages may include locally connected subnets that do not participate in OLSR (e.g., LV subnets), redistributed routes from other routing protocols, redistributed static routes, and default routes.

HomePlug protocol may be used to implement the ad hoc network protocol in some embodiments. Layer 2 broadcasts are transmitted via HomePlug ROBO mode. ROBO modulation schemes are more robust and travel much further than non-ROBO transmissions. In various embodiments, transmission of Alive Notifications, topology information, and routing information (and the contents thereof) may be at layer 2, layer 3, or a combination of layer 2 and 3.

At step 704, a given network element may receive routing information from any of its neighboring network elements and, over time, may receive routing information from a plurality of other network elements. At step 706, the network element receiving routing information may store all or part of the received routing information to thereby update its own routing table in memory. In addition, the routing table may be updated based on changes to the neighbor table (e.g., failure of a neighbor network element). Much of the updated (and received) routing information may be included in the subsequently transmitted routing information when the network element transmits its next HNA message, (e.g., repeating step 702). Process 700 may be repeated regularly such as once every hour, three hours, or day—depending on network reliability and constraints.

In some embodiments, the routing information exchanges may include path cost metrics. Path cost metrics may be based on neighbor availability and may be weighted as a function of time, number of hops and/or physical channel characteristics (e.g., reliability). Also, when a given network element updates its routing table, it may limit the updating to that information for network elements within a predetermined (or it may select a) number of hops, (e.g., two hops or three hops). Further, network elements may execute a loop prevention algorithm (stored in memory) to ensure that a given HNA transmission does not end up propagating in a loop.

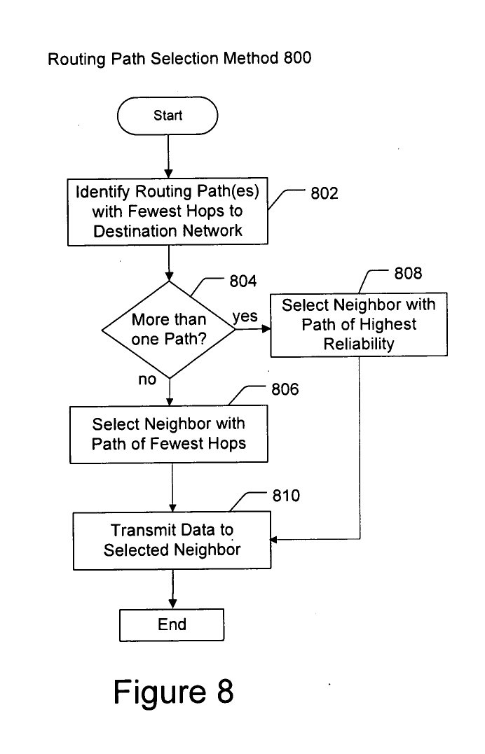

FIG. 8 illustrates a process for selecting a routing path 800, according to an example embodiment of the present invention to be executed by each network element. Each network element may determine a routing path through the PLCS for communicating with an external network or a LV subnet. A given routing path may be selected based upon the routing information exchanged by method 700 (FIG. 7) and the information obtained by the method 600 (FIG. 6). Further, path cost metrics, next hops, graphing theory, loop prevention, and other processes may be performed to identify a ‘best’ routing path. Accordingly, each power line network element may derive a routing path through the network for a data packet according to this process.

At step 802, the network element identifies one or more neighbor network elements that is the first hop of a routing path that has the fewest hops to the destination network, (e.g., the external network; a LV subnet) corresponding to a destination address of the data packet. To identify such neighbor(s), the network element may access its routing table. In particular by examining the routing table, the network element may identify the network elements communicating with the destination network and retrieve, compute or otherwise determine the number of hops for various routing path alternatives to the destination network.

At 804, the network element determines if there is more than one neighbor network element that forms part of a routing path having the fewest hops to the destination network. If at 804 there is a single routing path that has fewer hops than any other routing path, the process continues and the neighbor network element that is the first hop in that routing path is selected at 806.

If there is more than one routing path that has the fewest number of hops to the destination network, the process continues to step 808. As an example, if two different routing paths to the internet each includes three hops (and three hops is fewest hops available), then the process continues to step 808. The routing path having the highest reliability is selected to be preferred routing path to the destination and the neighbor network element that is the first hop in that routing path is selected at 808. Reliability may be determined using process 600 and as discussed above. Specifically, reliability is maintained and updated for each neighbor network element in the neighbor table via method 600, and may be used at step 808 as criteria for identifying the preferred routing path and selecting the neighbor network element. More specifically, the overall reliability of each routing data path may be compared, which may be the sum of the reliability of each of the links (e.g., three links when there are two hops) for each routing path. Accordingly, neighbor adjacencies and path cost metrics are used to determine best routing paths. Thus, in this embodiment, the reliability of communications across the entire routing path (or at least for multiple communication links of the routing path) is used to select the network element to which to transmit data destined for the destination network. In other embodiments, the reliability of communications with the neighbor network elements (i.e., which would be the first hop) may be used to select the network element that is the first hop of the routing path.

Note that in some embodiments the routing path selection method may include additional steps or criteria. For example, in some embodiments path reliability may be compared not just for potential paths with the same number of hops, but for potential paths with differing number of hops, (e.g., same +/1 hop). In such an example, when one potential routing path has four hops and two other routing paths have five hops, the path reliability of all three paths may be compared.

At 810, one or more data packets are generated containing the data, addressed for the selected neighbor network element, and transmitted over the power line. It is worth noting that this process 800 may then be performed by each network element periodically (e.g., once per hour or day) for each destination network to which the network element can transmit data. Information of the selected neighbor network element associated with each destination network may be stored in memory (e.g., in the routing table). Alternately, the process 800 may be performed just prior to transmission of data in order to determine to which network element to transmit the data.

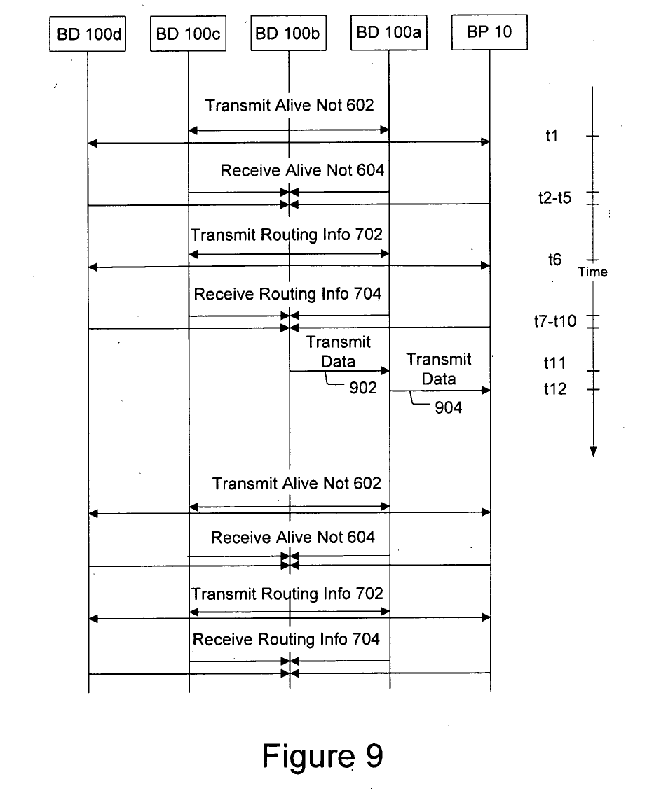

FIG. 9 illustrates the processes for the methods 600, 700 performed by a bypass device described above along a timeline. In this example, bypass devices 100a-d and BP 10 are each connected to an MV power line of an MV power line run (comprised of one to three MV power lines extending in parallel). Periodically each BD 100 may transmit Alive Notifications (process 602), such as at time t1. FIG. 9 illustrates the processes from the perspective of BD 100b. In this example, the Alive Notifications sent by BD 100b are received by the other BDs 100 and the BP 10 in the figure. Further BD 100b may regularly receive Alive Notifications (process 604) from various neighbor network elements BD 100a, BD 100c, BD 100d, BP 10, such as at times t2-t5 and at periodic intervals thereafter. Although the relative timing among transmitting and receiving of Alive Notifications is shown with all the receiving packets occurring subsequent to all the transmitting of Alive Notifications by BD 100b, the relative order may vary for any one or more of the message transmissions and receipts. Of significance, however, is that the cycles repeat. Topology information may also be exchanged such as immediately before the exchange of routing information.

In addition, periodically BD 100b may generate and transmit routing information (process 702), such as at time t6. Further BD 100b periodically may receive routing information (process 704) from various neighbor network elements BD 100a, BD 100c, BD 100d, BP10, such as at times t7-t10 and at periodic intervals thereafter. Again, although the relative timing among transmitting and receiving of routing information is shown with all the receiving occurring subsequent to all the transmitting, the relative order may vary for any one or more of the message transmissions and receipts.

In this example, a communication device (e.g., a user device or meter) at a customer premises connected the LV subnet served by BD 100b may transmit a data packet to an external network (e.g., the internet) via the PLCS, and a POP and AP 20 coupled to BP 10. The BD 100b may receive that data and perform process 800 and at 902 (at time t11) transmit the data to a neighbor network element BD 100a found to be the neighbor network element comprising the first hop in the preferred routing path (e.g., shortest and meeting predetermined reliability threshold in this example). The selection of BD 100a as part of the routing path to BP 10 was preceded by other independent processes periodically performed. The routing path selected by BD 100b is determined from the most recently updated routing information and reliability information received by BD 100b for each of its neighbors in accordance with process 800. Additionally, the selection of BD 100a need not to be performed in response to receiving data (although it could be), but may instead be periodically performed to determine the best routing path to each destination network accessible by the BD 100b.

At time t11, BD 100b may transmit the data to BD 100a. Thereafter at time t12, BD 100a may transmit the data to BP 10.

The processes described in FIG. 9 typically may performed by each network element. In addition, the processes of identifying the best routing path may be performed whether the data is received from a low voltage connected device (as described above) or from another network element (BD or BP) and irrespective of whether the data is upstream data (e.g., destined for the Internet) or downstream data (e.g., destined for a meter or user device).

It is worth noting that each network element may be attached to a power line such as a MV power line to receive and transmit data signals over that power line. In overhead power line systems, multiple power line phase conductors often run in parallel and high frequency data signals may cross couple (through the air) from a first power line phase conductor to one or more other power line phase conductors. Consequently, in many instances, some of the network elements may be connected to different power line phase conductors than other network elements and still be able to communicate with each other.

### Example BD—Path from LV Power Line to MV Power Line

As shown in FIG. 5, signals from the LV power line may enter the BD 100 via the LV coupler 410 and LV signal conditioner 420. Example of such circuitry that may be used in the BD 100 is provided in U.S. application Ser. No. 10/641,689, entitled “Power Line Communication System and Method of Operating the Same,” filed Aug. 14, 2003, and issued as U.S. Pat. No. 6,980,091, which is hereby incorporated by reference in its entirety. Any type of MV or LV coupler may be used including, but not limited to an inductive coupler, a capacitive coupler, a conductive coupler, or a combination thereof.

LV Modem

The LV modem 450 also may include one or more additional functional submodules such as an Analog-to-Digital Converter (ADC), Digital-to-Analog Converter (DAC), a memory, source encoder/decoder, error encoder/decoder, channel encoder/decoder, MAC (Media Access Control) controller, encryption module, and decryption module. These functional submodules may be omitted in some embodiments, may be integrated into a modem integrated circuit (chip or chip set), or may be peripheral to a modem chip. In the present example embodiment, the LV modem 450 is formed, at least in part, by part number INT51X1, which is an integrated power line transceiver circuit incorporating most of the above-identified submodules, and which is manufactured by Intellon, Inc. of Ocala, Fla.

The LV modem 450 provides decryption, source decoding, error decoding, channel decoding, and media access control (MAC) all of which are known in the art and, therefore, not explained in detail here.

With respect to MAC, however, the LV modem 450 may examine information in the packet to determine whether the packet should be ignored or passed to the router 310. For example, the modem 450 may compare the destination MAC address of the packet with the MAC address of the LV modem 450 (which is stored in the memory of the LV modem 450). If there is a match, the LV modem 450 removes the MAC header of the packet and passes the packet to the router 310. If there is not a match, the packet may be ignored.

Router

The data packet from the LV modem 450 may be supplied to the router 310, which forms part of the controller 300. The router 310 performs prioritization, filtering, packet routing, access control, and encryption. The router 310 of this example embodiment of the present invention uses a table (e.g., a routing table) derived using the ad hoc protocol routing methods 600, 700, 800 to determine the next destination of a data packet. The table is a collection of information and may include information relating to which interface (e.g., LVI 400 or MVI 200) leads to particular groups of addresses or networks (such as the addresses of the user devices and meters connected to the customer LV power lines and other BDs 100), priorities for connections to be used, and rules for handling both routine and special cases of traffic (such as voice packets and/or control packets).

The router 310 will detect routing information, such as the destination address (e.g., the destination IP address) and/or other packet information (such as information identifying the packet as voice data), and match that routing information with rules (e.g., address rules) in the table (and/or networks). The rules may indicate that packets in a particular group of addresses should be transmitted in a specific direction such as through the LV power line (e.g., if the packet was received from the MV power line and the destination IP address corresponds to a user device connected to the LV power line), repeated on the MV line (e.g., if the BD 100 is acting as a repeater), or be ignored (e.g., if the address does not correspond to a user device connected to the LV power line or to the BD 100 itself).

As an example, the table may include information such as the IP addresses (and potentially the MAC addresses) of the user devices and meters on the BD's LV subnet, the MAC addresses of the PLMs 50 on the BD's LV subnet, the MV subnet mask (which may include the MAC address and/or IP address of the BD's BP 10), the IP (and/or MAC) addresses of other BDs 100 (e.g., for which the device may repeat and/or use to repeat data), and the IP address of the LV modem 450 and MV modem 280. Based on the destination IP address of the packet (e.g., an IP address), the router may pass the packet to the MV modem 280 for transmission on the MV power line. Alternately, if the IP destination address of the packet matches the IP address of the BD 100, the BD 100 may process the packet as a command such as from the PLS.

In other instances, such as if the user device is not provisioned and registered, the router may prevent packets from being transmitted to any destination other than a DNS server or registration server. In addition, if the user device is not registered, the router 310 may replace any request for a web page received from that user device with a request for a web page on the registration server (the address of which is stored in the memory of the router).

The router 310 may also prioritize transmission of packets. For example, data packets determined to be voice packets may be given higher priority for transmission through the BD 100 than data packets so as to reduce delays and improve the voice connection experienced by the user. Routing and/or prioritization may be based on IP addresses, MAC addresses, subscription level, type of data (e.g., power usage data or other enhanced power distribution system data may be given lower priority than voice or computer data), or a combination thereof (e.g., the MAC address of the PLM or IP address of the user device).

MV Modem

Similar to the LV modem 450, the MV modem 280 receives data from the router 310 and includes a modulator and demodulator. In addition, the MV modem 280 also may include one or more additional functional submodules such as an ADC, DAC, memory, source encoder/decoder, error encoder/decoder, channel encoder/decoder, MAC controller, encryption module, frequency conditioning module (to upband and/or downband signals) and decryption module. These functional submodules may be omitted in some embodiments, may be integrated into a modem integrated circuit (chip or chip set), or may be peripheral to a modem chip. In the present example embodiment, the MV modem 280 is formed, at least in part, by part number INT51X1, which is an integrated power line transceiver circuit incorporating most of the identified submodules and which is manufactured by Intellon, Inc. of Ocala, Fla.

The incoming signal from the router 310 (or controller) is supplied to the MV modem 280, which provides MAC processing, for example, by adding a MAC header that includes the MAC address of the MV modem 280 as the source address and the MAC address of the BP 10 (and in particular, the MAC address of the MV modem of the BP) as the destination MAC address. In addition, the MV modem 280 also provides channel encoding, source encoding, error encoding, and encryption. The data is then modulated and provided to the DAC to convert the digital data to an analog signal.

MV Signal Conditioner

The modulated analog signal from MV modem 280 is provided to the MV signal conditioner 260, which may provide filtering (anti-alias, noise, and/or band pass filtering) and amplification. In addition, the MV signal conditioner may provide frequency translation. In this embodiment, the translation is from the 4-21 MHz band of the LV power line to the band of the MV power line, which in this embodiment may be a higher frequency band such as in the 30-50 MHz band. Thus, in this embodiment, HomePlug compliant (or compatible) data signals (e.g., HomePlug 1.0 or HomePlug AV) may be communicated on the LV power line to and from the customer premises. The use of an existing powerline communications standard may reduce the cost of the network and allow for easy installation of the equipment. Additionally, the same protocol (e.g., HomePlug 1.0 or AV) may also be used on the MV power lines at the same or at a different frequency band (e.g., 30-50 MHz). In another embodiment, the translation may be from the 4-30 MHz band of the LV power line to the band of the MV power line, which may be in the 24-50 MHz band. In this embodiment, translation of the frequency is accomplished through the use of a local oscillator and a conversion mixer.

MV Power Coupler Line

Data passing through the MV transmit/receive switch for transmission on the MV power line is supplied to the MV power line coupler 210, which may include impedance translation circuitry, transient suppression circuitry, and a coupling device. The coupling device couples the data onto the MV power line as a transmission.

The coupling device may be inductive, capacitive, conductive, a combination thereof, or any suitable device for communicating data signals to and/or from the MV power line. For example, the coupler may be formed of one or more surge arrestors as described in U.S. application Ser. No. 12/016,390, filed Jan. 18, 2008, entitled, “Power Line Coupling Device and Method,” which is hereby incorporated by reference in its entirety. Other examples of couplers that may be used are described in U.S. Pat. No. 7,224,243, entitled “Power Line Coupling Device and Method of Using the Same,” filed Sep. 2, 2005, which is hereby incorporated by reference in its entirety.

### Example BD—Path from MV Power Line to LV Power Line

MV Modem

The MV modem 280 receives the output of the first MV signal conditioner 260. The MV modem 280 and LV modem 450 provide a bidirectional path and form part of the MV to LV path and the LV to MV path. The components of the MV modem 280 have been described above in the context of the LV to MV path and are therefore not repeated here. The incoming signal is supplied to the ADC to convert the incoming analog signal to a digital signal. The digital signal is then demodulated. The modem then provides decryption, source decoding, error decoding, and channel decoding all of which are known in the art and, therefore, not explained in detail here.

The MV modem 280 also provides MAC processing through the use of MAC addresses. In one embodiment employing the present invention, the MAC address is used to direct data packets to the appropriate device. The MAC addresses provide a unique identifier for each device on the PLC network including, for example, user devices, BDs, PLMs, repeaters and BPs (i.e., the LV modems and MV modems of the BDs, repeaters, and the BPs).

In this embodiment, packets destined for a user device on a LV subnet of a BD 100 may be first addressed to the MAC address of the MV modem 280 of the BD 100 and may include additional information (e.g., the destination IP address of the user device/meter) for routing the packet to devices on the BD's LV subnet or to another BD 100.

If the destination MAC address of the received packet does not match the MAC address of the MV modem 280, the packet may be discarded (ignored). If the destination MAC address of the received packet does match the MAC address of the MV modem 280, the MAC header is removed from the packet and the packet is supplied to the router 310 for further processing (e.g., routing or processing as a command).

Router

The MAC address of a network device will be different from the IP address. Transmission Control Protocol (TCP)/IP includes a facility referred to as the Address Resolution Protocol (ARP) that permits the creation of a table that maps IP addresses to MAC addresses. The table is sometimes referred to as the ARP cache. Thus, the router 310 may use the ARP cache or other information stored in memory to determine IP addresses based on MAC addresses (and/or vice versa). In other words, the ARP cache and/or other information may be used with information in the data packet (such as the destination IP address) to determine the layer 2 routing of a packet (e.g., to determine the MAC address of the next downstream hop having the destination IP address).

As discussed above, upon reception of a data packet, the MV modem 280 of a BD 100 will determine if the destination MAC address of the packet matches the MAC address of the MV modem 280 and, if there is a match, the packet is passed to the router 310. If there is no match, the packet is discarded.

In this embodiment, the router 310 analyzes packets having a destination IP address to determine the destination network of the packet. This analysis includes comparing the information in the packet (e.g., a destination IP address) with network information stored in memory, which may include the IP addresses of the user devices/meters on the BD's LV subnet and for other destination networks in the routing table. If a match is found, the router 310 routes the packet through to the LV modem 450 for transmission on the LV power line. If the destination IP address corresponds the IP address of the BD 100, the packet is processed as a command or data intended for the BD 100 (e.g., by the Command Processing software described below) and may not be passed to the LV modem 450. If the destination network corresponds to a network serviced by another BD 100, the router may re-address the packet with the address of the selected BD (as determined according to processes described above) in a routing path to the destination network and pass the data to the MV modem for transmission onto the MV power line.

The term “router” is sometimes used to refer to a device that routes data at the IP layer (e.g., using IP addresses). The term “switch” or “bridge” are sometimes used to refer to a device that routes at the MAC layer (e.g., using MAC addresses). Herein, however, the terms “router”, “routing”, “routing functions” and the like are meant to include both routing at the IP layer and MAC layer. Consequently, the router 310 of the present invention may use MAC addresses instead of, or in addition to, IP addresses to perform routing functions.

In an alternate embodiment using IP address to route data packets, all packets received by the MV modem 280 may be supplied to the router 310. The router 310 may determine whether the packet includes a destination IP address that corresponds to a device on the BD's LV subnet (e.g., an address corresponding to a user device address or the BD's address). Specifically, upon determining the destination IP address of an incoming packet, the router 310 may compare the identified destination address with the addresses of the devices on the LV subnet, which are stored in memory. If there is a match between the destination address and the IP address of a user device stored in memory, the data is routed to the LV power line for transmission to the user device. If there is a match between the destination address and the IP address of the BD 100 stored in memory, the data packet is processed as a command or information destined for the BD 100.

In addition, the router 310 may also determine the destination network by processing the destination address and compare the destination network with the destination networks stored in the routing table. If there is no match, packet may be discarded (ignored). If there is a match, a network element is selected and the data transmitted to the selected network element as discussed above.

According to any of these router embodiments, the router may perform any or all of prioritization, packet routing, access control, filtering, and encryption. For example, voice packets may be given higher priority than data packets so as to reduce delays and improve the voice connection experienced by the user.

LV Modem

The functional components of the LV Modem 450 have been described above in the context of the LV to MV path and, therefore, are not repeated here. After receiving the data packet from the router 310, the LV modem 450 provides MAC processing, which may comprise adding a MAC header that includes the source MAC address (which may be the MAC address of the LV modem 450) and the destination MAC address (which may be the MAC address of the PLM 50 corresponding to the user device/meter identified by the destination IP address of the packet).

To determine the MAC address of the PLM 50 that provides communications for the user device identified by the destination IP address of the packet, the LV modem 450 first determines if the destination IP address of the packet is an IP address stored in its memory (e.g., stored in its bridging table). If the IP address is stored in memory, the LV modem 450 retrieves the MAC address for communicating with the destination IP address (e.g., the MAC address of the PLM 50) from memory, which will also be stored therein. If the IP address is not stored in memory, the LV modem 450 transmits a request to all the devices to which it is coupled via the low voltage power line (e.g., all the PLMs). The request is a request for the MAC address for communicating with the destination IP address of the packet. The device (e.g., the PLM) that has the MAC address for communicating with the destination IP address will respond by providing its MAC address. The LV modem 450 stores the received MAC address and the IP address for which the MAC address provides communications in its memory (e.g., in its bridging table). The LV modem 450 then adds the received MAC address as the destination MAC address for the packet.

The packet is then channel encoded, source encoded, error encoded, and encrypted. The data is then modulated and provided to the DAC to convert the digital data to an analog signal.

Controller

As discussed, the controller 300 includes the hardware and software for managing communications and control of the BD 100. In this embodiment, the controller 300 includes an IDT 32334 RISC microprocessor for running the embedded application software and also includes flash memory for storing the boot code, device data and configuration information (serial number, MAC addresses, subnet mask, and other information), the application software, routing table, and the statistical and measured data. This memory includes the program code stored therein for operating the processor to perform the routing functions described herein.

This embodiment of the controller also includes random access memory (RAM) for running the application software and temporary storage of data and data packets. This embodiment of the controller 300 also includes an Analog-to-Digital Converter (ADC) for taking various measurements, which may include measuring the temperature inside the BD 100 (through a temperature sensor such as a varistor or thermistor), for taking power quality measurements, detecting power outages, measuring the outputs of feedback devices, and others. The embodiment also includes a “watchdog” timer for resetting the device should a hardware glitch or software problem prevent proper operation to continue.

This embodiment of the controller 300 also includes an Ethernet adapter, an optional on-board MAC and physical (PHY) layer Ethernet chipset that can be used for converting peripheral component interconnect (PCI) to Ethernet signals for communicating with the backhaul side of the BD 100. Thus, the RJ45 connector may provide a port for a wireless transceiver (which may be a 802.11 compliant transceiver) for communicating wirelessly to the BP 10 or other BD 100, which, of course, would include a similar transceiver. In an alternate embodiment, the BD 100 may include a MV modem for the NB interface and an Ethernet port for the SB interface to communicate with user device.

In addition to storing a real-time operating system, the memory of controller 300 of the BD 100 also includes various program code sections such as a software upgrade handler, software upgrade processing software, the PLS command processing software (which receives commands from the PLS, and processes the commands, and may return a status back to the PLS), the ADC control software, the power quality monitoring software, the error detection and alarm processing software, the data filtering software, the traffic monitoring software, the network element provisioning software, and a dynamic host configuration protocol (DHCP) Server for auto-provisioning user devices (e.g., user computers) and associated PLMs.

In this embodiment, the router 310 (i.e., processor 320 executing the routing program code) shares a bus with the LV modem 450 and MV modem 280. Thus, the router 310 in this embodiment is not physically located between the two modems, but instead all three devices—the router 310, LV modem 450, and MV modem 280—are communicatively coupled together via the bus. In this embodiment the LV and MV modem physically share the same data bus, the bus is controlled by controller 300, meaning that packets go through the controller 300 and some level of the router 310. Alternately, in an alternate embodiment, in some instances (e.g., at the occurrence of a particular event) the router 310 may be programmed to allow the LV modem 450 to pass data directly to the MV modem 280 and vice versa, without performing data filtering and/or the other functions performed by the router 310 which are described above.

This embodiment of the BD 100 may only receive or transmit data over the LV power line at any one instant. Likewise, the BD 100 may only receive or transmit data over the MV power line at any one instant. However, as will be evident to those skilled in the art, the BD 100 may transmit or receive over the LV power line, while simultaneously transmitting or receiving data over the MV power line.

A backhaul point 10 may substantially all of the same components (and alternatives) as the bypass device 100 described herein, but may additionally include a network interface (that includes a suitable modem or transceiver) for communicating over a non-power line communication medium such as fiber optic, coaxial cable, DSL line, or wireless.

PLS Command Processing Software

The PLS and BD 100 may communicate with each other through two types of communications: 1) PLS Commands and BD responses, and 2) BD Alerts and Alarms. TCP packets are used to communicate commands and responses in the current embodiment. The commands typically are initiated by the NEM portion of the PLS. Responses sent by the BD 100 may be in the form of an acknowledgement (ACK) or negative acknowledgement (NACK), or a data response depending on the type of command received by the BD 100.

Commands

The PLS may transmit any number of commands to the BD 100 to support system control of BD functionality. For ease of discussion, however, the description of the commands will be in the context of a BD only, but may also be sent to a BP. These commands may include altering configuration information, synchronizing the time of the BD 100 with that of the PLS, controlling measurement intervals (e.g., voltage measurements of the ADC), requesting measurement or data statistics, requesting the status of user device activations, and requesting reset or other system-level commands. Any or all of these commands may require a unique response from the BD 100, which is transmitted by the BD 100 and received and stored by the PLS. The PLS may include software to transmit a command to any or all of the BDs 100 (and BPs 10) to schedule a voltage and/or current measurement at any particular time so that all of the network elements of the PLCS take the measurement(s) at the same time.

Alerts

In addition to commands and responses, the BD 100 has the ability to send Alerts and Alarms to the PLS (the NEM) via User Datagram Protocol (UDP), which does not require an established connection but also does not guarantee message delivery.

Alerts typically are either warnings or informational messages transmitted to the NEM in light of events detected or measured by the BD 100. Alarms typically are error conditions detected by the BD 100. Due to the fact that UDP messages may not be guaranteed to be delivered to the PLS, the BD 100 may repeat Alarms and/or Alerts that are critically important to the operation of the device or system.

One example of an Alarm is an Out-of-Limit Alarm that indicates that an out-of-limit condition has been detected at the BD 100, which may indicate a power outage on the LV power line, an MV or LV voltage to high, an MV or LV voltage too low, a temperature measurement inside the BD 100 is too high, and/or other out-of-limit conditions. Information of the Out-of-Limit condition, such as the type of condition (e.g., a LV voltage measurement, a BD temperature), the Out-of-Limit threshold exceeded, the time of detection, the amount (e.g., over, under, etc.) the out of limit threshold has been exceeded, is stored in the memory of the BD 100 and transmitted with the alert or transmitted in response to a request from the PLS.

Software Upgrade Handler

The Software Upgrade Handler software may be started by the BP 10 or BD 100 Command Processing software in response to a PLS command. Information needed to download the upgrade file, including for example the remote file name and PLS IP address, may be included in the parameters passed to the Software Command Handler within the PLS command.

Upon startup, the Software Command Handler task may open a file transfer program such as Trivial File Transfer Protocol (TFTP) to provide a connection to the PLS and request the file. The requested file may then be downloaded to the BD 100. For example, the PLS may transmit the upgrade through the Internet, through the BP 10, through the MV power line to the BD 100 where the upgrade may be stored in a local RAM buffer and validated (e.g., error checked) while the BD 100 continues to operate (i.e., continues to communicate packets to and from PLMs and the BP 10). Finally, the task copies the downloaded software into a backup boot page in non-volatile memory, and transmits an Alert indicating successful installation to the PLS. The BP 10 or BD 100 then makes the downloaded software the primary boot page and reboots. When the device restarts the downloaded software will be copied to RAM and executed. The device will then notify the PLS that it has rebooted via an alert indicating such.

ADC Scheduler

The ADC Scheduler software, in conjunction with the real-time operating system, creates ADC scheduler tasks to perform ADC sampling according to configurable periods for each sample type. Each sample type corresponds with an ADC channel. The ADC Scheduler software creates a scheduling table in memory with entries for each sampling channel according to default configurations or commands received from the PLS. The table contains timer intervals for the next sample for each ADC channel, which are monitored by the ADC scheduler.

ADC Measurement Software

The ADC Measurement Software, in conjunction with the real-time operating system, creates ADC measurement tasks that are responsible for monitoring and measuring data accessible through the ADC 330. Each separate measurable parameter may have an ADC measurement task. Each ADC measurement task may have configurable rates for processing, recording, and reporting for example.

An ADC measurement task may wait on a timer (set by the ADC scheduler). When the timer expires the task may retrieve all new ADC samples for that measurement type from the sample buffer, which may be one or more samples. The raw samples are converted into a measurement value. The measurement is given the timestamp of the last ADC sample used to make the measurement. The measurement may require further processing. If the measurement (or processed measurement) exceeds limit values, an alert condition may be generated. Out of limit Alerts may be transmitted to the PLS and repeated at the report rate until the measurement is back within limits. An out of limit recovery Alert may be generated (and transmitted to the PLS) when the out of limit condition is cleared (i.e., the measured value falls back within limit conditions).

The measurements performed by the ADC 330, each of which has a corresponding ADC measurement task, may include BD inside temperature, LV power line voltage, LV power line current (e.g., the voltage across a resistor), MV power line voltage, and/or MV power line current for example. MV power line measurements may be accomplished via a separate power line coupler, which may be an inductive coupler.

As discussed, the BD 100 includes value limits for most of these measurements stored in memory with which the measured value may be compared. If a measurement is below a lower limit or above an upper limit (or otherwise out of an acceptable range), the BD may transmit an Out-of-Limit Alert, which is received and stored by the PLS. In some instances, one or more measured values are processed to convert the measured value(s) to a standard or more conventional data value.

The measured data (or measured and processed data) is stored in the memory of the BD. This memory area contains a circular buffer for each ADC measurement and time stamp. The buffers may be read by the PLS Command Processing software functionality in response to a request for a measurement report or on a periodic basis. The measurement data may be backed up to non-volatile memory by a BD software task.

The LV power line voltage measurement may be used to provide various information. For example, the measurement may be used to determine a power outage, or measure the power used by a consumer or by all of the consumers connected to that distribution transformer. In addition, it may be used to determine the power quality of the LV power line by measuring and processing the measured values over time to provide frequency, harmonic content, and other power line quality characteristics.

The BD 100 also may include software for the gathering of repeating statistics, including but not limited to the number the packets and bytes transmitted from each repeated BD 100, the number of packets and bytes repeated for transmission to each repeated BD 100; and number of the packets dropped for each repeated BD 100. The BD software may include a code segment for setting and transmitting the statistics collection frequency in response to commands transmitted from the PLS.

The statistics collected may be stored periodically to non-volatile memory (e.g., at the same rate and times as the standard BD packet statistics).

The BD 100 also may include software for configuring a duration alert for transmitting a notice to the PLS that the statistics are ready or need to be transmitted to the PLS. The PLS may include software for determining when to collect periodic statistics and transmitting a request for the statistics in response to receiving the notice.

### Alternate Embodiments

As discussed, the BD 100 of the above embodiment communicates data signals to user devices/meters via the LV power line. Rather than communicating data signals to the PLM 50 and/or user devices via the LV power line, the BD 100 may use other communication media. For example, the BD may convert the data signals to a format for communication via a telephone line, fiber optic, RF cable, or coaxial cable line. Such communication may be implemented in a similar fashion to the communication with LV power line as would be well known to those skilled in the art.

In addition, the BD 100 may convert the data signal to wireless signals for communication over a wireless communication link to the user device/meter. In this case, the user device may be coupled to a wireless transceiver for communicating through the wireless communication link. The wireless communication link may be a wireless link implementing a network protocol in accordance with an IEEE 802.11 (e.g., a, b, g, or n) standard.

In any of these non-power line links to the customer premises, the BD 100 may include another transceiver, which may be a PLM, DOCSIS modem, digital subscriber line (DSL) modem, fiber optic transceiver, or wireless transceiver that is suitable for the access link. This transceiver may be employed instead of, or in addition to, the LVI described above, as determined by the architecture of the system. Thus, user devices/meters in some customer premises may communicate with the BD 100 via a coaxial cable (via a first modem in the BD 100) and user devices in other customer premises may communicate with the BD 100 via their low voltage power lines (via a second modem in the BD, which may be a power line modem chip set). In some embodiments of the PLCS, the system may include a filter device (e.g., low pass filter) at or near the power meter so that in-home power line network communications do not egress onto the LV subnet and interfere with the power line communications between the BD 100 and other customer premises.

Miscellaneous

As discussed, the functions of the PLM may be integrated into a smart utility meter such as a gas meter, electric meter, or water meter. The meter may be assigned an IP address by the PLCS (e.g., by the PLS) and, upon receiving a request or at predetermined intervals, transmit data such as consumption data to the BD 100, the PLS, and/or a utility computer system in a manner described herein, thereby eliminating the need to have utility personnel physically travel to read the meter. Thus, the meters may transmit real time power usage data, which may be stored at the PLS. A customer (or operator) may then access a database (e.g., via the internet with a web browser) to determine his or her real-time pricing (RTP), critical peak pricing (CPP) and time-of-use (TOU) pricing. The operator may further determine the total power being utilized by the network, and compare the data with the power being supplied to determine the efficiency of the network. In addition, one or more addressable switches, which may form part of a utility meter, may be controlled via the PLCS (e.g., with commands transmitted from the BD 100, the PLS, and/or utility computer system) to permit connection and disconnection of gas, electricity, and/or water to the customer premises. The meter also may be connected to the BD 100 via a coaxial cable that is connected to a connector on the meter collar, thereby providing a separate link to the meter. In addition, if a data filter has been installed on the LV power line, the coaxial cable may be coupled to the LV power line(s) on the customer premises side of the filter via the PLCC device described above to provide a path around the filter. The coaxial cable may provide a customer premises access link that does not interfere with other customers on the same LV subnet, because the coaxial cable is not connected to the other customer premises while the LV power lines of all the customer premises on the LV subnet are connected.

Similarly, the PLCS may be used to control MV power line switches. The addressable MV power line switch may be a motorized switch and assigned an IP address by the PLS, which is also provided to the utility computer system to thereby operate the switch. When a power outage is detected, the utility company may remotely operate one or more addressable MV power line switches to provide power to the area where the outage is detected by transmitting commands to the IP addresses of the switches.

Likewise, the PLCS may be used to monitor, control and automate a capacitor switch that inserts or removes a capacitor (or capacitor bank) into the power distribution system. Capacitor banks are used to improve the efficiency of the power distribution network by providing Volt/VAR management (e.g., modifying the reactance of the power distribution network). Thus, the PLS may assign an IP address to one or more capacitor switches, which is also provided to the utility computer system to thereby operate the switch. Based on power quality measurements taken and received from one or more BDs 100, the utility company may insert or remove one or more capacitor banks by remotely actuating one or more capacitor bank switches by transmitting commands to the IP addresses of the switches.

The capacitor switch and the MV power line switch may be controlled by an embodiment of the present invention that includes an MV interface and controller. In addition, in some embodiments an LV interface may also be employed.

The BD 100 may also include one or more electric current sensors, which may include a magnetically permeable toroid and winding therethrough. At the utility pole, each current sensor may be coupled around a separate LV energized conductor connected to a customer premises. The winding may be connected to a resistor (which also is connected to ground) that is also connected an ADC, whose voltage may be periodically read by the processor. Thus, the BD 100 may periodically measure the current flowing to each customer premises (in each LV energized conductor), which may be processed, stored, and transmitted to the PLS (which may further process, store, and/or transmit the data). Because the BD 100 may also measure the voltage supplied to the customer premises, the BD 100 may thus be used to measure the power consumption of each customer premises. The real-time power consumption data may be stored in memory of the PLS or another computer and be supplied to the user upon transmitting a request for power usage data, which may be supplied to the user along with the real-time consumption cost to the user (i.e., the user's utility bill to date) via the PLCS. The data may also be processed by the BD 100 or PLS to provide customer load characteristics and patterns. Other sensors that may be connected to the BD 100 may include a camera (e.g., for monitoring security, detecting motion, confirming a truck roll, vegetation management, or monitoring automobile traffic flow), an audio input device (e.g., microphone for detecting noise, noise patterns, or particular sounds—any of which may be a precede and therefore predict an insulator or other EPDN component failure), a vibration sensor, a motion sensor (e.g., an infrared motion sensor), a wind speed and direction sensor, a thermometer (for measuring ambient temperature or measuring the temperature of the transformer casing, which may be value in predicting a transformer failure), and/or a barometer. The cameras also may be used to monitor electrical power distribution network infrastructure, such as substations, or to view power usage meters therein or elsewhere. The camera may be remotely controlled to allow zooming in, zooming out, panning left, right, up, or down. The video data or other sensed data may be transmitted via the PLCS to a remote computer for processing or may be processed by the BD 100. If the BD 100 or remote computer makes a detection (e.g., detects noise or a particular sound, detects motion, detects a qualified vibration, detects a pole tilt, etc.), an automated notification may be transmitted to the utility company or a user as the case may be. Such notification may also traverse the PLCS.

Other sensors that may be connected to, or integrated with, a power line modem inside the customer premises and communicate data via the BD 100 to a user device via the PLCS and Internet. Such sensors may include a camera (e.g., for monitoring security, detecting motion, monitoring children's areas, monitoring a pet area), an audio input device (e.g., microphone for monitoring children, detecting noises), a vibration sensor, a motion sensor (e.g., an infrared motion sensor for security), a home security system, a smoke detector, a heat detector, a carbon monoxide detector, a natural gas detector, a thermometer, a barometer. The video data, audio or other sensed data may be transmitted via the PLCS to a remote computer for processing and/or presentation (audibly, visually, textually, and/or graphically) to the user via the internet on a presentation device such as a computer, mobile telephone, personal digital assistant (PDA), or other device. In addition, the power line modem may be connected to, or integrated with, control devices to allow the user to similarly remotely monitor (e.g., to receive settings and/or status such as on or off) and control (e.g., to turn on, turn off, and/or change settings) various home appliances and systems via any of the same user devices. For example, the power line modem may be connected to, or integrated into, a thermostat (to control heat and air conditioning and/or temperature setting), humidifier, air filtering mechanism, home computer, personal video recorder (e.g., to remotely set or start recording), tuner, digital cable set top box, video cassette recorder, stereo, oven, audio input device, video camera(s), refrigerator, dishwasher, hot water heater, fan, light, lighting system (e.g., to turn on or off select lights), copier, printer, answering machine, router, sprinkler system (e.g., to turn on or off select sprinklers), whirlpool (e.g., to remotely fill and/or heat), pool (e.g., to control heating, lighting, and/or filtering), motion sensor, home security system, smoke detector, natural gas detector, carbon monoxide detector, and heat detector. Likewise, detections by these sensors (e.g., a smoke detector detecting smoke) may cause a notification to be sent to the user device via the PLCS.

In the above embodiment, the processor performs routing functions and may act as a router in some instances and perform other functions at other times depending on the software that is presently being executed. The router may also be a chip, chip set, or circuit board (e.g., such as an off the shelf circuit card) specifically designed for routing, any of which may include memory for storing, for example, routing information (e.g., the routing table) including MAC addresses, IP addresses, and address rules.

Finally, the type of data signal coupled by the coupling device may be any suitable type of data signal. The type of signal modulation used can be any suitable signal modulation used in communications (Code Division Multiple Access (CDMA), Time Division Multiple Access (TDMA), Frequency Division Multiplex (FDM), Orthogonal Frequency Division Multiplex (OFDM), and the like). OFDM may be used for one or both of the LV and MV power lines. A modulation scheme producing a wideband signal such as CDMA or OFDM that is relatively flat in the spectral domain may be used to reduce radiated interference to other systems while still delivering high data communication rates.

In addition, instead of using OFDM signals on the MV power line or LV power line, an alternate embodiment of a PLCS system may use ultra wideband signals or surface wave signals (Goubau waves) to provide communications over the MV and/or LV power lines. In another embodiment, instead of using the MV power lines, the signals, which may be OFDM, UWB, surface waves signals, or another type of signal, may be transmitted on the neutral conductor(s) that span from transformer to transformer. Use of the neutral conductor may reduce the need to isolate from the high voltage of the MV power line and thereby reduce the cost of installation and of the coupler.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method of using a power line communication node to establish a power line communications system, the method comprising:
transmitting an Alive Notification over a power line;
receiving one or more Alive Notifications transmitted from other power line nodes via the power line;
wherein each Alive Notification includes data identifying an interface of the transmitting node;
wherein each Alive Notification further includes information identifying an interface of one or more other nodes from which the transmitting node has received an Alive Notification;
for each received Alive Notification, storing in a memory the data identifying the interface of the transmitting node and the information identifying an interface of one or more other nodes from which the transmitting node has received an Alive Notification;
transmitting routing information over the power line;
wherein the routing information includes information identifying the transmitting node;
wherein the routing information further includes information identifying one or more networks accessible by the node;
receiving routing information from a plurality of nodes;
storing the routing information in the memory;
selecting a route to a network based on the routing information stored in memory that includes the fewest nodes;
identifying a first node that comprises a first hop of the selected route; and
transmitting data to the first node.

2. The method according to claim 1, further comprising:
transmitting topology information over the power line;
receiving topology information via the power line; and
storing at least some of the received topology information in memory.

3. The method according to claim 1, wherein the Alive Notification further includes reliability information;

4. The method according to claim 1, wherein the transmitted routing information includes information identifying a low voltage subnet of the node.

5. The method according to claim 1, wherein said selecting further comprises selecting a route having the greatest reliability.

6. The method according to claim 1, wherein at least some of the nodes receive and transmit Alive Notifications over different power lines.

7. A method of using a communication node, comprising:
transmitting over a power line identifying information of the node to one or more other communication nodes;
receiving via the power line information identifying the one or more other communication nodes;
storing in a memory the received information identifying the one or more other communication nodes;
transmitting over the power line topology information to the one or more other communication nodes;
receiving via the power line topology information from the one or more other communication nodes;
storing in the memory at least some of the received topology information;
generating routing table from information stored in the memory;
transmitting over the power line routing information to the one or more other communication nodes;
receiving via the power line routing information from the one or more other communication nodes; and
storing in the memory at least some of the received routing information.

8. The method according to claim 7, wherein the transmitted identifying information comprises an address of an interface of the node that is connected to the power line.

9. The method according to claim 7, wherein the transmitted identifying information comprises an address stored in memory of, and associated with, the node.

10. The method according to claim 7, further comprising selecting a communication node as a multi-point relay for re-transmitting data.

11. The method according to claim 7, further comprising transmitting over the power line information identifying the one or more communication nodes from which identifying information was received.

12. The method according to claim 7, further comprising transmitting over the power line at least a portion of the topology information received from the one or more other communication nodes.

13. The method according to claim 7, wherein further comprising transmitting over the power line at least a portion of the routing information received from the one or more other communication nodes.

14. The method according to claim 7, further comprising transmitting over the power line at least a portion of the routing information received from the one or more other communication nodes.

15. The method according to claim 7, further comprising:
selecting a route to a network based on the routing information stored in memory;
identifying a first communication node that comprises a first hop of the selected route; and
transmitting data to the first power line node.

16. The method according to claim 7, further comprising determining path cost data for communications with a plurality of other communication nodes.

17. The method according to claim 7, further comprising updating reliability information in memory to reflect a reduced communication reliability of a first communication node in response to a failure to receive an Alive Notification from the first communication node.

18. A method of using a communication node, comprising:
transmitting via a power line identifying information of the node to one or more other communication nodes;
receiving via the power line information identifying the one or more other communication nodes;
storing in a memory the received information identifying the one or more other communication nodes;
generating routing table from information stored in the memory;
transmitting via the power line routing information to the one or more other communication nodes;
receiving via the power line routing information from the one or more other communication nodes; and
storing in the memory at least some of the received routing information.

19. The method according to claim 18, wherein the transmitted identifying information comprises an address of an interface of the communication node that is connected to the power line.

20. The method according to claim 18, wherein the transmitted identifying information comprises an address stored in memory of and associated with the communication node.

21. The method according to claim 18, further comprising transmitting over the power line information identifying the one or more communication nodes from which identifying information was received.

22. The method according to claim 18, wherein further comprising transmitting over the power line at least a portion of the routing information received from the one or more other communication nodes.

23. The method according to claim 18, further comprising:
selecting a route to a network based on the routing information stored in memory;
identifying a first communication node that comprises a first hop of the selected route; and
transmitting data to the first power line node.

24. The method according to claim 23, wherein said selecting is based on reliability information of each available route and the number of hops of each available route.

25. The method according to claim 18, further comprising in response to a failure to receive one or more transmissions of information identifying from a first communication node within a predetermined time period, updating reliability information associated with the first communication node stored in memory to reflect a reduced communication reliability.

26. A method of using a communication node, comprising:
transmitting over a power line identifying information of the node to one or more other communication nodes;
receiving via the power line information identifying the one or more other communication nodes;
storing in a memory the received information identifying the one or more other communication nodes;
storing reliability information in memory in association with each of the one or more other communication nodes;
wherein the one or more other communication nodes includes a first communication node;
in response to a failure to receive information identifying the first communication node within a predetermined time period, updating reliability information associated with the first communication node in memory to reflect a reduced communication reliability with the first communication node.
selecting a route from a plurality of available routes to a network for transmission of data based on the reliability information stored in memory;
identifying a first communication node that comprises a first hop of the selected route; and
transmitting data over the power line to the first communication node.

27. The method according to claim 26, further comprising:
generating a routing table from information stored in the memory;
transmitting over the power line routing information to the one or more other communication nodes;
receiving via the power line routing information from the one or more other communication nodes; and
storing in the memory at least some of the received routing information.

28. The method according to claim 27, further comprising transmitting over the power line at least a portion of the routing information received from the one or more other communication nodes.

29. A power line communication device, comprising:
a power line interface configured to communicate over a power line;
a downstream interface configured to communicate with one or more power usage meters;
a controller having memory storing executable program code and in communication with said downstream interface and said power line interface;
wherein said controller is configured to:
cause said power line interface to transmit over a power line an Alive Notification to one or more other communication nodes;
receive via the power line interface, Alive Notifications from the one or more other communication nodes;
store in the memory information in at least some of the received Alive Notifications;
generate routing information from information stored in the memory;
cause said power line interface to transmit over the power line at least some of the routing information to the one or more other communication nodes;
receive via the power line interface, routing information transmitted from the one or more other communication nodes; and
store in the memory at least some of the received routing information.

30. The device according to claim 29, wherein said controller is configured to select a communication node as a multi-point relay for re-transmitting topology information.

31. The device according to claim 29, wherein said controller is configured to cause said power line interface to transmit over the power line at least a portion of the information in the received Alive Notifications.

32. The device according to claim 29, wherein said controller is configured to transmit over the power line via the power line interface at least a portion of the routing information received from the one or more other communication nodes.

33. The device according to claim 29, wherein said controller is configured to:
select a route to a network for transmission of data based on the routing information stored in memory;
identify a first communication node that comprises a first hop of the selected route; and
cause said power line interface to transmit data to the first power line node.

34. The device according to claim 33, wherein said controller is configured to select the route based on reliability information of each available route and the number of hops of each available route.

35. The device according to claim 29, wherein said controller is configured to update updating reliability information in memory to reflect a reduced communication reliability with a first communication node in response to a failure to receive an Alive Notification from the first communication node.
